(19) United States
(12) Patent Application Publication
(10) Pub. No.: US 2010/0050168 A1
(43) Pub. Date: Feb. 25, 2010

(54) SECURE FIRMWARE UPDATES IN EMBEDDED SYSTEMS

(75) Inventor: Sergei Sharonov, Houston, TX (US)

Correspondence Address: CONLEY ROSE, P.C.;David A. Rose, PO BOX 3267, HOUSTON, TX, 77253-3267, US

(73) Assignee: HALLIBURTON ENERGY SERVICES, INC., Houston, TX (US)

(21) Appl. No.: 12/518,825

(22) PCT Filed: Dec. 19, 2006
(86) PCT No.: PCT/US06/62311

§ 371 Date: Jun. 11, 2009

(51) Int. Cl. G06F 9/44; G06F 9/24

(52) U.S. Cl. 717/173; 700/87; 713/2

(57) ABSTRACT

An oilfield borehole device comprising a storage device including a first software image and a data structure, the data structure to include at least one of an address, a file identifier and a flag. The device further comprises a processor to download a second software image from a second storage device external to the oilfield borehole device, the second storage device associated with the address and the second software image associated with the file identifier. The processor replaces the first software image with the second software image and changes a status of the flag after replacement of the first software image.

### BACKGROUND

Many commercial systems and consumer products rely on embedded computer systems to perform their functions. Embedded computer systems often take the form of general purpose microprocessors or microcontrollers to carry out specialized functions by firmware, i.e., software instructions stored in a nonvolatile memory. Because this design does not rely on customized hardware components, it offers flexibility and a reduced-time to market. In many cases, the firmware may be updated to fix software defects or to introduce new features. However, such updates carry a risk—if for some reason the nonvolatile memory becomes corrupted, the embedded system ceases to operate properly. Typically, such a failure is difficult to correct because the embedded system ceases communicating. The consequences of such a failure can be substantial in many systems where manual access to the embedded system is limited, e.g., industrial equipment in hazardous environments, spacecraft, and borehole logging instrumentation. Yet it is precisely in such environments where such failures are prone to occur due to communications fade-outs, power fluctuations, or stray radiation. Existing update methods do not adequately insure against the risk of failure.

### BRIEF DESCRIPTION OF THE DRAWINGS

For a detailed description of illustrative embodiments of the invention, reference will now be made to the accompanying drawings in which:

FIG. 1 illustrates a logging-while-drilling (LWD) system in accordance with various embodiments;

FIG. 2 illustrates a wireline logging system in accordance with various embodiments;

FIG. 3 illustrates a processing module in accordance with various embodiments;

FIG. 4 illustrates a flow diagram of a process in accordance with various embodiments;

FIG. 5 shows a data structure used by the process of FIG. 4, in accordance with various embodiments;

FIG. 6A shows a partially disassembled logging tool that houses the processing module of FIG. 3 in accordance with various embodiments; and

FIG. 6B shows a detailed view of a sidewall readout port of the partially disassembled tool of FIG. 6A, in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “Including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Further, the term “update” is intended to encompass modifiations of any kind, including an “upgrade,” an “overwrite,” etc. Further still, in at least some cases, the terms “software” and “software image” may be used interchangeably. Yet further still, the term “flag” may be interpreted to mean any suitable type of indicator, including a single bit, a set of bits or some other type of indicator.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be illustrative of that embodiment, and not intended to suggest that the scope of the disclosure, including the claims, is limited to that embodiment.

Described herein is a technique by which software stored on an embedded computer system is updated with little or no risk of system infirmity. More specifically, the technique enables the software to be updated such that, even in the event that the software update is interrupted, the system still maintains operability. The disclosed systems and methods are particularly suitable for use with oilfield equipment including logging tools that are part of a larger assembly.

FIG. 1 shows an illustrative logging while drilling (LWD) environment including a drill string with one or more tools having software that may be updated using the techniques disclosed herein. A drilling platform 2 supports a derrick 4 having a traveling block 6 for raising and lowering a drill string 8. A kelly 10 supports the drill string 8 as it is lowered through a rotary table 12. A drill bit 14 is driven by a downhole motor and/or rotation of the drill string 8. As bit 14 rotates, it creates an oilfield borehole 16 that passes through various formations 18. A pump 20 circulates drilling fluid through a feed pipe 22 to kelly 10, downhole through the interior of drill string 8, through orifices in drill bit 14, back to the surface via the annulus around drill string 8, and into a retention pit 24. The drilling fluid transports cuttings from the borehole into the pit 24 and aids in maintaining the borehole integrity.

A LWD tool 26 is integrated into the bottom-hole assembly near the bit 14. As the bit extends the borehole through the formations, logging tool 26 collects measurements relating to various formation properties as well as the bit position and various other drilling conditions. The logging tool 26 may take the form of a drill collar, i.e., a thick-walled tubular that provides weight and rigidity to aid the drilling process. A telemetry sub 28 may be included to transfer tool measurements to a surface receiver 30 and to receive commands from the surface receiver 30.

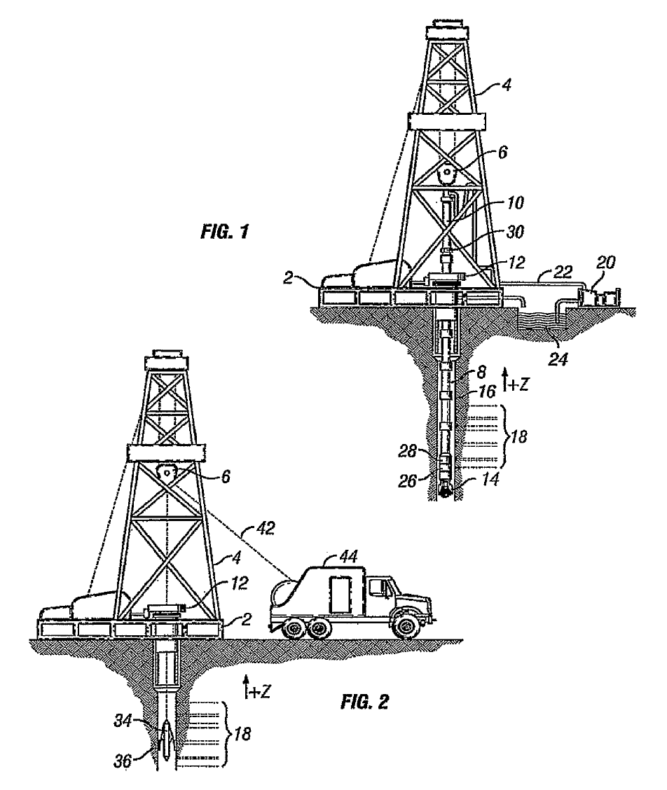

At various times during the drilling process, the drill string 8 may be removed from the borehole. Once the drill string has been removed, logging operations can be conducted. Such logging operations are shown in FIG. 2. The logging operations are conducted using a wireline logging tool 34, i.e., a sensing instrument sonde suspended by a cable 42 having conductors for transporting power to the tool and telemetry from the tool to the surface. A logging facility 44 collects measurements from the logging tool 34, and includes computing facilities for processing and storing the measurements gathered by the logging tool. The computing facilities may take the form of a personal computer, server, digital signal processing board or some other form of computing circuit. The computing facilities may access the Internet and/or another network via wired or wireless connections (not specifically shown).

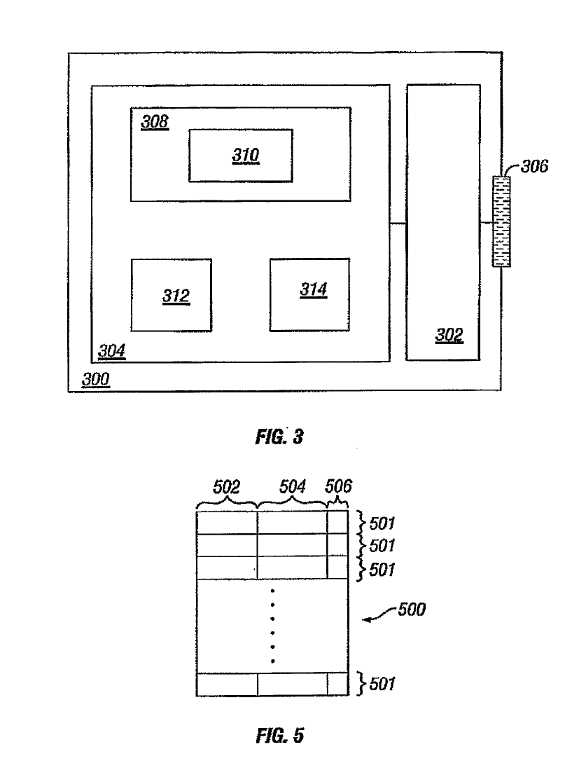

Any suitable portion of the drill string 8 (e.g., the tool 26) and/or any suitable portion of the sonde 34 may contain processing logic 300 (i.e. an embedded system), an illustrative embodiment of which is shown in FIG. 3. The processing logic 300 may serve any of a variety of purposes, including uphole/downhole communications, tool operations, logging operations, etc. The processing logic 300 includes a processor 302 and a storage 304 including one or more types of memory (e.g., non-volatile memory, flash memory). The processor 302 couples to an input/output (I/O) port 306 to transfer data to and from another electronic device (e.g., a computer) coupled to the processing logic 300 via the I/O port 306. The storage 304 stores various software, including an operating system (OS) 308 (e.g., UNIX®, LINUX®, WINDOWS®) and a bootloader 312 used to initialize the OS 308. The OS 308 may include a software update application (SUA) 310, although in some embodiments, the SUA 310 may be stored separate from the OS 308. When executed by the processor 302, the SUA 310 enables the processor 302 to download software updates needed for the software updating technique, as described below. The storage 304 may store other software and data, such as firmware 314, used for system administration/housekeeping, logging measurements and/or other such activities. The firmware 314 may include any suitable type of software, such as an OS, user applications, etc. The software updating technique mentioned above may be used to update any software (e.g., firmware 314) stored on the storage 304. One or more units of software may be updated. The software updating technique also may be used to download new software to the storage 304. The remainder of this document shall refer to both updated software and new software as “software updates,” “updated software” or a similar term.

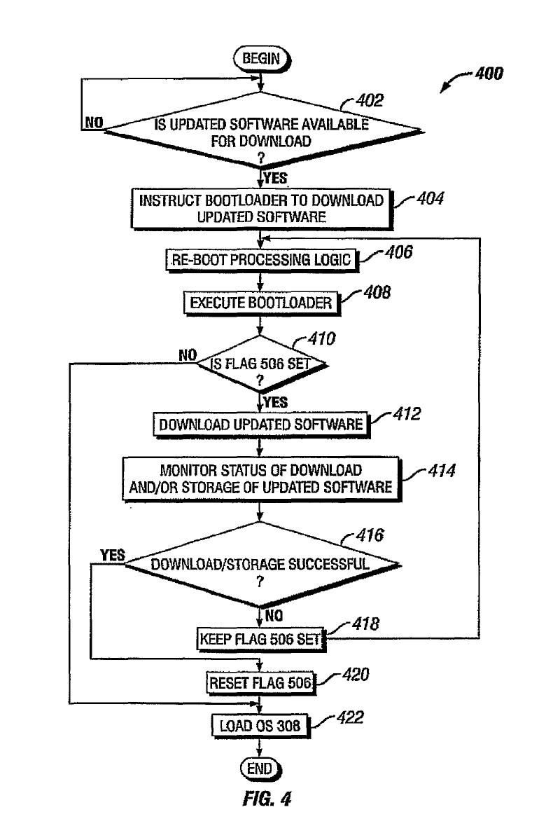

FIG. 4 shows a flow diagram of a method 400 describing one embodiment of the software updating technique. The method 400 may be manually triggered by an operator. Alternatively, the method 400 may be performed at regularly scheduled intervals which may be programmed into the processing logic 300. Referring to FIG. 4, the method 400 begins with the processor 302 executing SUA 310 to determine whether updated software is available for download (block 402). The processor 302 may use the SUA 310 to determine updated software availability using at least any of the wired and/or wireless communication techniques described above. In some embodiments, the updated software is stored on a surface computer (e.g., facility 44). Alternatively, the updated software may be stored on a separate computer (e.g., a server or, in some embodiments, multiple servers) with which the surface computer communicates (e.g., via an Internet communication protocol, such as a file transfer protocol (FTP) network connection, a hypertext transfer protocol overview (HTTP) network connection, a network file system (NFS) network connection). Specifically, execution of the SUA 310 causes the processor 302 to send a query signal to a predetermined entity (e.g., the aforementioned surface computer) to determine whether the entity is ready to provide the updated software to the processing logic 300. In turn, the predetermined entity may send a response signal to the processing logic 300 indicating whether the updated software is available for download. A location of the predetermined entity (e.g., an Internet protocol (IP) address) is programmed into the SUA 310 but may be changed as desired.

If, by executing the SUA 310, the processor 302 determines (e.g., using the technique described above) that the updated software is available for download (block 402), the method 400 then includes the SUA 310 causing the processor 302 to instruct the bootloader 312 to download the updated software upon the next reboot of the processing logic 300 (block 404). The SUA 310, when executed by the processor 302, causes the processor 302 to program a predefined area of storage 304 with the information needed by the bootloader 312 to download the updated software upon next reboot. In alternative embodiments, the updated software may be downloaded as soon as the processor 302 determines that the updated software is available for download (i.e., prior to a re-boot). In at least some such embodiments, the SUA 310 causes the processor 302 to begin download of the updated application and to program the predefined area of storage 304 with information needed by the bootloader 312 to resume updated software download if the current download is interrupted and the processing logic 300 is re-booted. In such cases, an indicator (e.g., the flag 506, described below) may be used to indicate to the bootloader 312 that the update software download needs to be resumed upon reboot.

Regardless of whether the updated software is downloaded prior to or after a re-boot, the predefined area of storage 304 is programmed using a data structure such as that shown in FIG. 5. FIG. 5 shows an illustrative data structure 500 that may be programmed with various information used to regulate the download of updated software. The data structure 500 is stored in storage 304 and includes one or more entries 501. Each entry may include fields 502, 504 and 506. Field 502 includes an address, such as a server name or an IP address (hereinafter “IP address 502”) of the entity storing the updated software. Field 504 contains one or more file identifiers (e.g., filename(s) or release version(s), hereinafter “Fl 504”) associated with the updated software. Field 506 includes an indicator, such as a flag (hereinafter “flag 506”). The SUA 310 may cause the processor 302 to set or reset the flag 506 (e.g., one or more bits) in the storage 304. Upon boot up, a set flag 506 will indicate to the bootloader 312 that a software download must be initiated, or that a previously initiated but incomplete software download must be resumed. For example, if the updated software is downloaded prior to re-boot, but the download is unsuccessful, the flag may be set so that upon re-boot, the download is resumed.

The method 400 then includes the SUA 310 causing the processor 302 to re-boot the processing logic 300 (block 406). In some embodiments, the SUA 310 may cause the processor 302 to provide a user of the processing logic 300 the option of re-booting the processing logic 300 at a later time. For example, using a computer coupled to the I/O port 306, the user may be able to specify a future time at which to re-boot the processing logic 300. During re-boot, the status of the flag 506 indicates the status of an associated updated software download. For example, a set flag may indicate that the processing logic 300 re-booted before the downloaded, updated software was properly stored. Alternatively, a set flag may indicate that no software was downloaded at all. Similarly, a reset flag may indicate that updated software was downloaded and properly installed.

Upon re-booting, the bootloader 312 is executed by the processor 302 (block 408). The bootloader 312 is programmed to cause the processor 302 to determine the status of the flag 506 upon execution (block 410). If the processor 302 determines that the flag 506 is set, the bootloader 312 causes the processor 302 to download (or resume downloading) the updated software (block 412) having filename(s) and/or release version(s) that match Fl 504. The updated software is downloaded from the entity whose IP address matches IP address 502. The bootloader 312 may cause the processor 302 to write the downloaded software image or files to an unused portion of the storage 304. Alternatively, the bootloader 312 causes the processor 302 to overwrite a portion of, or all of, software already stored on the storage 304 with the updated software. In some embodiments, such an overwrite includes the replacement of one software image with a different software image.

For example, if, by executing the SUA 310, the processor 302 determines that updated software (having a filename “SOFTWARE_UPDATE.EXE”) is available for download from a server having an IP address of 65.70.55.89, the SUA 310 causes the processor 302 to program an entry 501 in the data structure 500 with the IP address 65.70.55.89 and the filename SOFTWARE_UPDATE.EXE. The SUA 310 also causes the processor 302 to set the flag in the entry 501. Upon reboot, the bootloader 312, in tandem with the processor 302, will detect the set flag and take the set flag as a cue to begin downloading the file SOFTWARE_UPDATE.EXE from the entity at the IP address 65.70.55.89. As previously mentioned, although any type of updated software file(s) may be downloaded (such as the illustrative, executable file mentioned above), entire software images preferably are downloaded.

The bootloader 312 causes the processor 302 to monitor the status of the download and/or storage of the updated software (block 414). In at least some embodiments, the processor 302 monitors the status of the download by, e.g., verifying a checksum of a downloaded software image and verifying that the downloaded image is stored in non-volatile memory.

If the download and/or storage process is interrupted for any reason (e.g., events that leave the software only partially installed or updated, such as a power failure, a hardware or software failure, interconnect problems, operator/user error, etc.) or is otherwise unsuccessful (block 416), the bootloader 312 prevents the processor 302 from altering the status of the flag 506. Instead, the flag 506 is kept in a “set” state (block 418). In this way, upon re-start of the processing logic 300, the bootloader 312 determines the flag 506 is still set, indicating that the updated software has not yet been property downloaded and stored to the storage 304. In that case, the bootloader 312 may cause the processor 302 to re-start the download and storage operation altogether. Preferably, however, the boottoader 312 causes the processor 302 to resume the previous download/storage operation.

The previous download/storage operation may be resumed using the data structure 500. Although not specifically shown in FIG. 5, in at least some embodiments, one or more entries 501 in the data structure 500 may contain a destination address indicating where software updates obtained from the indicated IP address are to be stored on the processing logic 300. In the event that a software update is not properly performed and the processing logic 300 is re-booted, the bootloader 312 causes the processor 302 to check the destination address indicated in the entry 501 to determine whether the software update was properly downloaded and installed (e.g., whether the software at the destination address is functional). If the software update was not properly downloaded or installed, the bootloader 312 causes the processor 302 to resume the download/storage operation to the destination address indicated in the entry 501. The scope of this disclosure is not limited to this particular technique, however, and other techniques for determining the status of a previously performed software download/storage operation also are possible.

When the processor 302 determines that the updated software has been properly downloaded and stored to storage 304 (block 416), the bootloader 312 causes the processor 302 to reset the flag 506 (block 420). Because the flag 506 is no longer set, at the next re-boot, the processor 302 will not attempt to download the updated software. After the bootloader 312 causes the processor 302 to reset the flag 506 (block 420), the method 400 includes the bootloader loading the OS 308 (block 422).

In some cases, multiple flags in multiple entries 501 may be set. Each set flag may be associated with a different software update that is to be performed. In such cases, the steps of blocks 406 to 420 of FIG. 4 are repeated as necessary until each set flag has been reset due to a successful software update.

In some cases, a hardware or software glitch may prevent the successful update of software. In such cases, at least some of the steps of process 400 may be repeatedly performed with little or no success. Accordingly, the bootloader 312 may be programmed to quit attempting software updates after a predetermined number of attempts. For example, the bootloader 312 may be programmed to quit attempting software updates after ten update attempts have failed. In such a case, after the tenth update attempt fails, the bootloader 312 may cause the processor 302 to cease from further update attempts (e.g., by resetting the corresponding flag in the data structure 500) and may further cause the processor 302 to generate an alert signal. In some embodiments, such an alert signal may take the form of a lit light-emitting-diode (LED) (not specifically shown) coupled to the processing logic 300. In other embodiments, such an alert signal may take the form of an electronic message or signal delivered to an electronic device (e.g., a computer) external to the processing logic 300 (e.g., the facility 44) via the I/O port 306. Upon receiving the signal, a user may then attempt to correct the glitch and resume attempts to update the software.

The process described in context of FIG. 4 may be performed while the processing logic 300 is either downhole or at the surface. In embodiments where the processing logic 300 is included in the sonde 34, the processing logic 300 may be located downhole and thus may contain software that is updated downhole. Communications (e.g., software downloads) may be performed between the processing logic 300 and the logging facility 44 by way of the cable 42. In at least some embodiments, the logging facility 44 has access to a network and/or the Internet. In some such embodiments, the processing logic 300 may download information (e.g., software updates or upgrades) from the network and/or Internet by accessing the logging facility 44.

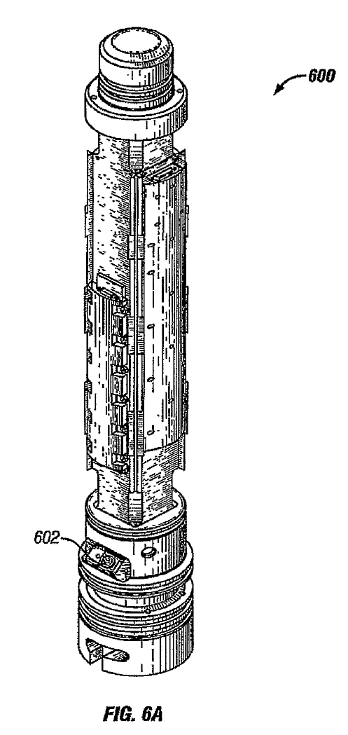

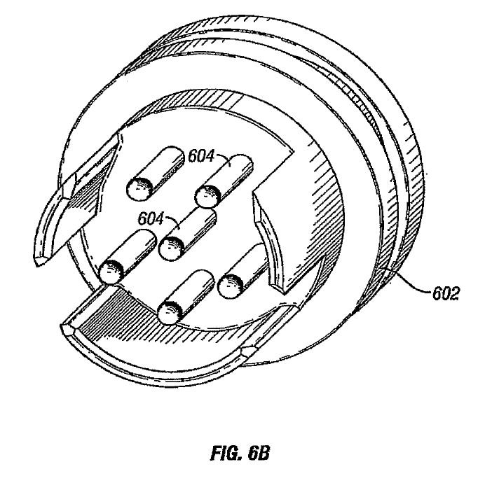

In some embodiments, the processing logic 300 is included in the drill string 8, such as in the tool 26. A partially disassembled tool 600 is shown in FIG. 6A. The tool 600 includes a sidewall readout port 602 that can be easily accessed after the tool is fully assembled and incorporated into a drill string. Compared to other techniques in which an operator must dismantle, e.g., a tool to access an embedded processing logic to update software, the sidewall readout port 602 facilitates easy electronic access to the embedded processing logic 300 and enables an operator to quickly update software. In this way, both operating downtime and opportunity cost are reduced or minimized.

In some embodiments, the sidewall readout port 602 may couple to the I/O port 306. In other embodiments, the sidewall readout port 602 may be considered to be the I/O port 306. A more detailed view of the sidewall readout port 602 is provided in FIG. 6B. As shown in FIG. 6B, the sidewall readout port 602 includes a plurality of pins 604 capable of mating with a communication cable (not specifically shown) that couples to a computer, e.g., housed in the facility 44. In this way, data is transferred between the processing logic 300 and any electronic device coupled to the processing logic 300. In such embodiments where the processing logic 300 is stored in a drill string 8, the process of FIG. 4 preferably is performed with the partially disassembled tool 600 (i.e., the processing logic 300) at the surface.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An oilfield borehole device, comprising:
a storage device comprising a first software image and a data structure, said data structure to include at least one of an address, a file identifier and a flag; and
a processor to download a second software image from a second storage device external to the oilfield borehole device, said second storage device associated with the address and said second software image associated with the file identifier; and
wherein the processor replaces the first software image with the second software image and changes a status of the flag after replacement of the first software image.

2. The oilfield borehole device of claim 1, wherein, if the processor re-boots, the processor resumes replacement of the first software image if the flag is set.

3. The oilfield borehole device of claim 1, wherein the processor sets the flag before the second software image replaces the first software image, and wherein the processor resets the flag only after the second software image has replaced the first software image.

4. The oilfield borehole device of claim 3, wherein, if said replacement is interrupted, the flag is kept set while the processor re-boots.

5. The oilfield borehole device of claim 1, wherein the device is selected from the group consisting of a wireline tool and a drill string.

6. The oilfield borehole device of claim 1, wherein the processor downloads the second software image via an Internet connection.

7. The oilfield borehole device of claim 1, wherein said address is selected from the group consisting of an Internet protocol (IP) address and a server name.

8. The oilfield borehole device of claim 1, wherein, if the processor has resumed said replacement a predetermined number of times, the processor stops attempting to resume said replacement.

9. The oilfield borehole device of claim 8, wherein the processor stops attempting to resume said replacement by resetting said flag.

10. The oilfield borehole device of claim 8, wherein the processor generates an alert signal indicating that the processor is unable to successfully perform said replacement.

11. The oilfield borehole device of claim 1, wherein the processor determines whether to resume said replacement by determining whether executable code located at a destination address is operational, said destination address associated with said flag.

12. A method, comprising:
adjusting a flag to a first status;
downloading an updated software image from a storage to a processing logic of a well-logging device, said logic separate from said storage;
replacing a previous software image on said logic with the updated software image; and
if said replacement is complete, adjusting said flag to a second status.

13. The method of claim 12 further comprising, if said replacement is interrupted, re-booting said logic and resuming said replacement.

14. The method of claim 12 further comprising re-booting said processing logic and, if said flag is adjusted to the first status, resuming said replacement.

15. The method of claim 12, wherein, if said replacement is interrupted, keeping said flag adjusted to the first status while rebooting said processing logic.

16. The method of claim 12, wherein downloading said updated software image comprises using an Internet connection.

17. The method of claim 12, wherein downloading said updated software image comprises transferring to said storage an Internet protocol (IP) address associated with said storage and a filename associated with said updated software image.

18. The method of claim 12, wherein downloading said updated software image comprises using a sidewall readout port coupled to said processing logic.

19. A system, comprising:
a device used to obtain measurements in an oilwell borehole, comprising:
processing logic; and
a first storage coupled to the processing logic, the first storage to include a first software image and a flag adjusted to a first state; and
a storage, external to said device, to communicate with the processing logic and to include a second software image;
wherein the processing logic receives the second software image from the storage and replaces the first software image with the second software image;
wherein the processing logic adjusts the flag to a second state after said replacement is complete.

20. The system of claim 19, wherein, if said replacement is interrupted, the processing logic re-boots and automatically resumes said replacement.

21. The system of claim 19, wherein the processing logic automatically resumes said replacement during a re-boot.

22. The system of claim 19, wherein, if said replacement is interrupted, the flag is kept set to the first state while the processing logic is re-booted.

23. The system of claim 19, wherein the flag is indicative of completion of said replacement, and wherein if, after the processing logic re-boots, the flag is set to the first state, the processing logic attempts to complete said replacement.

24. The system of claim 19, wherein the device is selected from the group consisting of a wireline tool and a drill string.

25. The system of claim 19, wherein the processing logic replaces the first software image with the second software image while the processing logic is located at the surface of the borehole.

26. The system of claim 19, wherein the processing logic replaces the first software image with the second software image while the processing logic is located downhole.

27. The system of claim 19, wherein said storage provides said second software image to the processing logic by way of a network connection.

28. The system of claim 27, wherein said processing logic downloads said second software image from the storage via the network connection by transferring to the storage information selected from the group consisting of an Internet protocol (IP) address of said storage and a filename associated with said second software image.

29. The system of claim 19, wherein said processing logic receives the second software image via a sidewall readout port, said sidewall readout port exposed to an outer surface of the device.
